(19) United States
(12) Patent Application Publication
(10) Pub. No.: US 2023/0048206 A1
(43) Pub. Date: Feb. 16, 2023

(54) CONTROLLING MACHINE LEARNING MODEL STRUCTURES

(71) Applicant: Hewlett-Packard Development Company, L.P., Spring, TX (US)

(72) Inventors: Madhu Sudan Athreya, Palo Alto, CA (US); Manu Rastogi, Palo Alto, CA (US); M. Anthony Lewis, Palo Alto, CA (US); Thomas da Silva Paula, Porto Alegre (BR)

(73) Assignee: Hewlett-Packard Development Company, L.P., Spring, TX (US)

(21) Appl. No.: 17/794,134

(22) PCT Filed: Feb. 6, 2020
(86) PCT No.: PCT/US2020/016978

§ 371 Date: Jul. 20, 2022

(51) Int. Cl. G06N 3/04; G06N 3/08

(52) U.S. Cl. CPC G06N 3/0454; G06N 3/08

(57) ABSTRACT

Examples of methods for controlling machine learning model structures are described herein. In some examples, a method includes controlling a machine learning model structure. In some examples, the machine learning model structure may be controlled based on an environmental condition. In some examples, the machine learning model structure may be controlled to control apparatus power consumption associated with a processing load of the machine learning model structure.

### BACKGROUND

Electronic technology has advanced to become virtually ubiquitous in society and has been used to improve many activities in society. For example, electronic devices are used to perform a variety of tasks, including work activities, communication, research, and entertainment. Electronic technology is implemented from electronic circuits. Different varieties of electronic circuits may be implemented to provide different varieties of electronic technology.

### BRIEF DESCRIPTION OF THE DRAWINGS

FIG. 1 is a flow diagram illustrating an example of a method for controlling a machine learning model structure;

FIG. 2 is a flow diagram illustrating an example of a method for controlling a machine learning model structure;

FIG. 3 is a block diagram of an example of an apparatus that may be used in controlling a machine learning model structure or structures;

FIG. 4 is a block diagram illustrating an example of a computer-readable medium for controlling machine learning model components; and

FIG. 5 is a block diagram illustrating an example of components that may be utilized to control a machine learning model structure or structures.

### DETAILED DESCRIPTION

A machine learning model is a structure that learns based on training. Examples of machine learning models may include artificial neural networks (e.g., deep neural networks, convolutional neural networks (CNNs), recurrent neural networks (RNNs), etc.). Training the machine learning model may include adjusting a weight or weights of the machine learning model. For example, a neural network may include a set of nodes, layers, and/or connections between nodes. The nodes, layers, and/or connections may have associated weights. Examples of the weights may be in a relatively large range of numbers and may be negative or positive. The weights may be adjusted to train the neural network to perform a function or functions. For example, machine learning (e.g., deep learning) may be implemented in a variety of applications, such as object detection (e.g., detecting a face in an image), image classification (e.g., classifying an image as including a type of object), navigation (e.g., navigating a robot or autonomous vehicle to a location while avoiding obstacles), speech recognition, three-dimensional (3D) printing (e.g., geometry prediction, deformation compensation), etc.

Machine learning model training and/or machine learning model inferencing may consume relatively large amounts of computation and/or power resources. Some techniques may be utilized to reduce resource consumption during training.

Training or learning is performed in a training period or training periods. During a training period, a machine learning model may be trained with labeled data or ground truth data (for supervised learning, for instance). For example, labeled data or ground truth data may include input training data with target output data (e.g., classification(s), detection(s), etc.) to train the machine learning model weights. In some examples of unsupervised learning, an error function may be used to train the machine learning model. Some examples of the machine learning models described herein may be trained using supervised learning, and/or some examples of the machine learning models described herein may be trained using unsupervised learning.

A machine learning model may be utilized for inferencing once the machine learning model is trained. Inferencing is the application of a trained machine learning model. For example, a trained machine learning model may be utilized to inference (e.g., predict) an output or outputs. Inferencing may be performed outside of and/or after a training period or training periods. For example, inferencing may be performed at runtime, when the machine learning model is online, when the machine learning model is deployed, and/or not during a training period. During inferencing (e.g., runtime), for example, runtime data (e.g., non-training data, unlabeled data, non-ground truth data, etc.) may be provided as input to a machine learning model.

In some examples, a camera on a device such as a laptop computer may be utilized to perform object detection (e.g., facial detection, person detection, etc.) utilizing a neural network. Some autonomous smart camera-based inferencing devices (e.g., robots and drones) may be deployed in the field (e.g., farmlands, industrial environments, etc.) and may be battery-powered. In order to perform sophisticated inferencing, some devices may run deep neural networks that may consume a relatively large amount of processing and/or power resources. For example, inferencing with deep learning may consume a relatively large amount of power, thus increasing device power consumption and/or shortening battery life. For instance, frequently recharging and/or replacing batteries may increase operational expense and lower the usefulness of some devices. It may be beneficial to provide techniques for improving inferencing performance, improving inferencing efficiency, and/or reducing power consumption during inferencing. Some examples of the techniques described herein may improve inferencing performance, may improve inferencing efficiency, and/or may reduce power consumption during inferencing.

Some examples of the techniques described herein may enable controlling a machine learning model structure. A machine learning model structure is a machine learning model or models and/or a machine learning model component or components. Examples of machine learning model components may include nodes, connections, and/or layers. For instance, a machine learning model structure may include a neural network or neural networks, a layer or layers, a node or nodes, a connection or connections, etc. Some machine learning model components may be hidden. For instance, a machine learning model component between an input layer and an output layer may be a hidden machine learning model component (e.g., hidden node(s), hidden layer(s), etc.). In some examples, a machine learning model structure (e.g., deep neural network structure) may be dynamically controlled and/or modified according to inferencing performance. Some examples of the techniques described herein may improve power efficiency (e.g., reduce power consumption) during inferencing for a machine learning model structure. For instance, some examples of the techniques described herein may enable longer battery life. Some examples of the techniques described herein may maintain inferencing accuracy. Some examples of the techniques described herein may be implemented in an apparatus or apparatuses (e.g., electronic device(s), computing device(s), mobile device(s), smartphone(s), tablet device(s), laptop computer(s), camera(s), robots, printers, vehicles (e.g., autonomous vehicles), drones, etc.).

The machine learning model (e.g., neural network) structure power efficiency may be improved to extend the battery life. Similar improvements in power efficiency may be implemented with autonomous smart camera-based inferencing devices. Conserving battery life may enable extending device operation between charges. Accordingly, efficient inferencing processing may reduce power consumption and/or extend battery life.

In some approaches, deep learning networks may be trained for worst-case scenarios. Training for worst-case scenarios may be beneficial because exact inferencing conditions may be unknown during training, and demanding conditions may occur at the time of inferencing. Accordingly, training for worst-case scenarios may provide accurate performance in demanding conditions at the time of inferencing. However, deep learning networks may work similarly to a worst-case scenario, even when a scenario is less demanding than the worst-case training. For instance, the deep learning networks may be over-provisioned when the scenario is less the worst case. In many applications, the worst-case conditions may occur for a part of the time. For example, a camera that is deployed during nighttime may be presented with noisy and poorly illuminated images. During the daytime, the camera may be presented with well-illuminated subjects and less-noisy images. For instance, the nighttime scenario may be deemed as a worst-case scenario, while the daytime scenario may be less demanding. In the daytime scenario, the network may be modified to reduce complexity and/or power consumption. Reducing complexity and/or power consumption of the network may make a minor sacrifice in overall accuracy, although the network may still be capable of inferencing at a high accuracy for the brightly illuminated images.

Some of the techniques described herein may reduce a trained machine learning model structure while providing an inferencing target (e.g., meeting an inferencing accuracy target). A variety of techniques may be utilized to reduce the machine learning model structure during inferencing. In some examples, controlling the machine learning model structure may include dropping (e.g., removing, deactivating, etc.) a random selection of machine learning model components. In some examples, controlling the machine learning model structure may include selecting a sub-network or sub-networks of machine learning model components. In some examples, controlling the machine learning model structure may include controlling quantization. In some examples, controlling the machine learning model structure may include selecting a machine learning model or machine learning models from a machine learning model ensemble. Examples of the some of the techniques described herein may be implemented in electronic devices, such as always-on cameras (which may be utilized to control the machine learning model structure), battery-life challenged drones, robots, and/or self-driving cars. A variety of electronic devices may benefit from low-power inferencing enabled by some of the techniques described herein.

Throughout the drawings, identical or similar reference numbers may designate similar, but not necessarily identical, elements. The figures are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

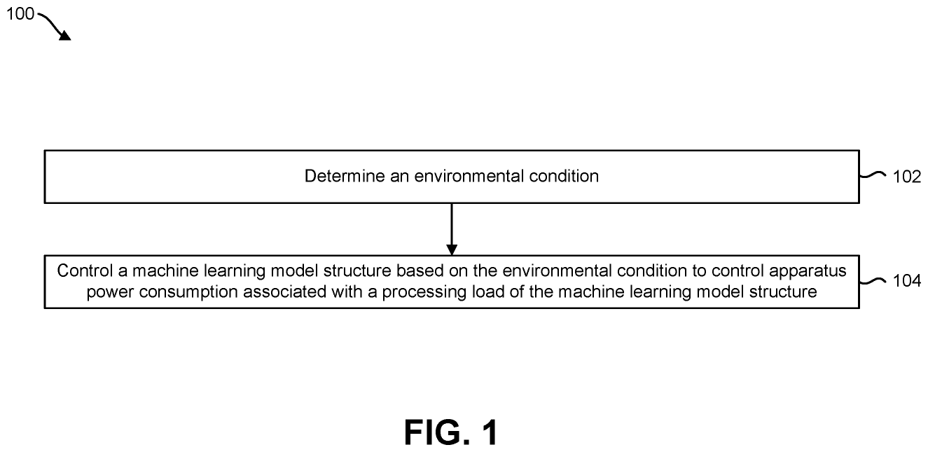

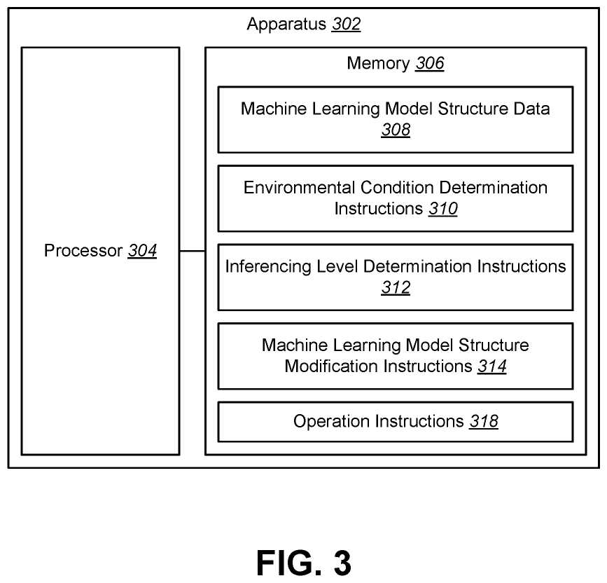

FIG. 1 is a flow diagram illustrating an example of a method 100 for controlling a machine learning model structure. The method 100 and/or an element or elements of the method 100 may be performed by an apparatus (e.g., electronic device). For example, the method 100 may be performed by the apparatus 302 described in connection with FIG. 3.

The apparatus may determine 102 an environmental condition. An environmental condition is an indication of a state or circumstance of an environment. Examples of states or circumstances of an environment may include lighting (e.g., lighting brightness, lighting color, etc.), position of an object or objects in an environment (e.g., position of a person, position of a face, presence of a distracting object or objects, lighting source position, image sensor placement, camera placement, light sensor placement, etc.), acoustic noise, motion, time, etc., of an environment. Examples of environmental conditions may include an illumination condition (e.g., luminance, brightness, detected color, light wavelength, light frequency, etc.), a pose condition (e.g., object position, object pose, pixel location, measured depth, distance to an object, three-dimensional (3D) object position, object rotation, camera pose, target object zone, etc.), optical signal-to-noise ratio (SNR), acoustic noise density, acoustic SNR, object speed, object acceleration, and/or time, etc. For example, an environmental condition may be a metric or measurement of a state or circumstance of an environment. In some examples, an environmental condition may include multiple conditions (e.g., illumination condition and pose condition).

An illumination condition is an indication of a state of illumination of an environment. For instance, an illumination condition may indicate brightness, light intensity, illuminance, luminance, luminous flux, pixel brightness, etc. In some examples, an illumination condition may be expressed in units of candela, watts, lumens, lux, nits, footcandle, etc. In some examples, the illumination condition may be expressed as a value, a histogram of values, an average of values, a maximum value (from a set of values), a minimum value (from a set of values), etc.

In some examples, determining 102 the environmental condition may include detecting the environmental condition. For example, the apparatus may detect the environmental condition using a sensor or sensors (e.g., image sensor(s), light sensor(s), etc.). In some examples, the environmental condition may be based on illumination and/or pose.

In some examples, the apparatus may detect an illumination condition using an image sensor or sensors. For example, the apparatus may include or may be linked to an image sensor or sensors (e.g., camera(s)). The image sensor(s) may capture an image or images (e.g., image frame(s)). The image sensor(s) (and/or an image signal processor) may provide data that may indicate (and/or that may be utilized to determine) the illumination condition. For example, an image sensor may provide pixel values (e.g., a frame or set of pixel values) that may be utilized to determine the illumination condition. In some examples, an image sensor (and/or an image signal processor) may provide a statistic and/or a histogram of data that may indicate (and/or that may be utilized to determine) the illumination condition. The statistic(s) and/or histogram of data may indicate a count, prevalence, distribution, and/or frequency of values (e.g., pixel values, pixel brightness values, etc.) sensed by the image sensor(s). The histogram may or may not be visually represented. The data or histogram of data may be utilized to determine the illumination condition. For instance, an average (e.g., mean, median, and/or mode), a maximum, a minimum, and/or another metric may be calculated based on the data provided by the image sensor(s) to produce the illumination condition.

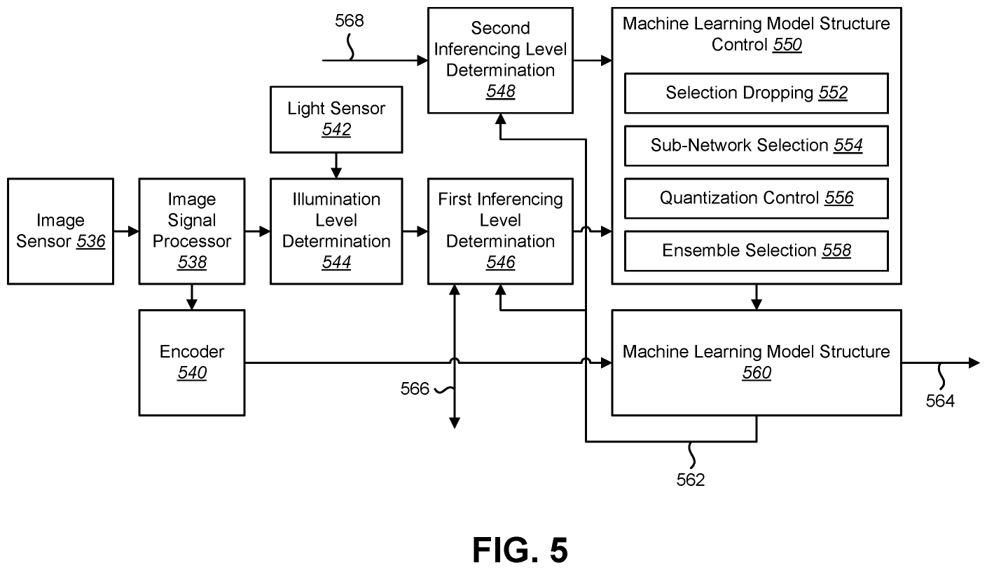

In some examples, the apparatus may detect an illumination condition using a light sensor or sensors. For example, the apparatus may include or may be linked to a light sensor or sensors (e.g., camera(s)). The light sensor(s) may capture and/or provide data that may indicate (and/or that may be utilized to determine) the illumination condition. For example, a light sensor may provide a value or values that may be utilized to determine the illumination condition. Some approaches for determining 102 an illumination condition are described in relation to FIG. 5.

A pose condition is an indication of a pose of an object or objects and/or a pose of a sensor or sensors. A pose may refer to a position, orientation, and/or view (e.g., perspective) of an object. For example, a pose condition may indicate a pose of an object in an environment and/or relative to a sensor. For instance, a pose condition may indicate whether a front or a side (e.g., profile) of a face appears in an image or images captured by an image sensor.

In some examples, the apparatus may detect a pose condition using an image sensor or sensors. For example, the apparatus may include or may be linked to an image sensor or sensors (e.g., camera(s)) that may provide data that may indicate (and/or that may be utilized to determine) the pose condition. For example, the apparatus may perform face detection and/or may determine a portion of a face that is visible in an image or images. For example, the apparatus may determine whether a facial feature or facial features (e.g., eye(s), nose, mouth, chin, etc.) are shown in an image. For instance, the apparatus may indicate a profile pose of a face in a case that one eye, one mouth corner, and/or one nostril are detected in an image. In a case that two eyes, two mouth corners, and/or two nostrils are detected, the apparatus may indicate a frontal pose of a face, for example.

In some examples, determining 102 the environmental condition may include receiving an indication of the environmental condition. For example, the apparatus may include and/or may be linked to an input device. Examples of input devices may include a touch screen, keyboard, mouse, microphone, port (e.g., universal serial bus (USB) port, Ethernet port, etc.), communication interface (e.g., wired or wireless communication interface(s)), image sensor(s) (e.g., camera(s)), etc. The apparatus may receive an input that indicates the environmental condition. For instance, the input may indicate an illumination condition and/or a pose condition.

The apparatus may control 104 a machine learning model structure based on the environmental condition to control (or regulate, for example) apparatus power consumption associated with a processing load of the machine learning model structure. Apparatus power consumption is an amount of electrical power (or energy over time) used by, or to be used by, an apparatus. A processing load is an amount of processing (e.g., processor cycles, processing complexity, proportion of processing bandwidth, memory usage, and/or memory bandwidth, etc.). The apparatus power consumption associated with a processing load of the machine learning model structure may indicate an amount of electrical power used to execute the processing load of the machine learning model structure. For example, a more complex machine learning model structure may provide a greater processing load and a higher power consumption than a less complex machine learning model structure. A machine learning model structure may vary in processing load and/or power consumption based on a number of machine learning models included in the machine learning model structure and/or a number of machine learning model components (e.g., layers, nodes, connections, etc.) included in the machine learning model structure. The apparatus may control 104 the machine learning model structure based on the environmental condition by controlling the number of machine learning models (e.g., neural networks) and/or the number of machine learning model components the machine learning model structure.

In some examples, the apparatus may control 104 the machine learning model structure by reducing machine learning model structure complexity when the environmental condition is favorable to inferencing accuracy (e.g., when the environmental condition may increase inferencing accuracy). Reducing the machine learning model structure complexity may reduce the processing load and/or power consumption associated with the machine learning model structure. When the environmental condition is favorable to inferencing accuracy, inferencing accuracy may be maintained while the machine learning model structure complexity is reduced. In some examples, the apparatus may increase machine learning model structure complexity when the environmental condition is unfavorable to inferencing accuracy (e.g., when the environmental condition may decrease inferencing accuracy). When the environmental condition is unfavorable to inferencing activity, inferencing accuracy may be maintained (e.g., inferencing errors may be avoided) by increasing the machine learning model structure complexity.

In some examples, controlling 104 the machine learning model structure may include determining an inferencing level based on the environmental condition. An inferencing level is an amount of inferencing complexity or quality. For instance, a higher inferencing level may be associated with greater machine learning model structure complexity, and a lower inferencing level may be associated with lesser machine learning model complexity. Different inferencing levels may correspond to or may be mapped to different environmental conditions. For example, an inferencing level may be determined based on the environmental condition using a rule or rules (e.g., thresholds), a lookup table, and/or a selection model. In some examples, the apparatus may compare the environmental condition to a threshold or thresholds to select an inferencing level. In some examples, the apparatus may look up an inferencing level in a lookup table using the environmental condition. In some examples, the apparatus may utilize a selection model (e.g., a machine learning model, a neural network, etc.) that may infer an inferencing level based on the environmental condition. For example, the selection model may learn from inferencing error and/or confidence feedback to select an inferencing level that reduces inferencing error and/or increases confidence relative to the environmental condition.

In some examples, determining the inferencing level may be based on an inverse relationship between an illumination condition and the inferencing level. For instance, a greater illumination condition (e.g., greater amounts of light) may correspond to a lower inferencing level, where less machine learning model structure complexity may be utilized to infer a result with good accuracy. A lesser illumination condition (e.g., lesser amounts of light) may correspond to a higher inferencing level, where greater machine learning model complexity may be utilized to infer a result with good accuracy.

In some examples of the techniques described herein, the apparatus may capture an image(s) using an image sensor and/or may sample a light level using an ambient light sensor to determine an illumination condition. Based on the input(s) (e.g., based on the illumination condition), the apparatus may determine the inferencing level. For instance, the apparatus may utilize a rule or rules, a lookup table, and/or a selection model to determine the inferencing level based on the illumination condition. The inferencing level may be stored as data and/or may be asserted as a signal. In some examples, inferencing levels may be related in a hierarchy or range. For instance, inferencing levels may be expressed as L1, L2, L3, etc., where L1 is a lower inferencing level, where L2 is a higher inferencing level than L1, and L3 is a higher inferencing level than L2, etc. For instance, L1 may be selected when the illumination condition indicates good subject illumination for an image sensor. In some examples, L1 may allow active power conservation due to well-illuminated subjects from the image sensor(s). In some examples, a higher level (e.g., L5) may indicate that more complex inferencing may be utilized when the illumination condition is demanding. Accordingly, L5 may indicate greater power consumption than L1. By varying machine learning model structure complexity in accordance with the inferencing level, the apparatus may reduce average power consumption.

In some examples, controlling 104 the machine learning model may include selecting a machine learning model or models from a machine learning model ensemble. A machine learning model ensemble is a group of machine learning models (e.g., neural networks). For example, a machine learning model or models may be selected from a set of pre-trained machine learning models. In some approaches, neural networks in a machine learning model ensemble may be used to reduce variance by combining predictions from multiple machine learning models. In some examples of the techniques described herein, a machine learning model or models (e.g., neural network(s)) may be selected for the machine learning model structure to perform a particular inferencing task. The machine learning model ensemble may include multiple machine learning models (e.g., pre-trained deep neural networks (DNNs)), from which machine learning model or models are selected to reduce apparatus power consumption during inferencing.

Different machine learning models in a machine learning model ensemble may be trained differently. For example, a machine learning model (e.g., DNN) may be trained to generalize across a wide range of subjects (e.g., different object types for object detection, different pose conditions such as different poses of objects for object detection, different illumination conditions, etc.). To achieve target accuracy, machine learning hyperparameters may be set. A hyperparameter is a parameter of a machine learning model relating to the structure and/or function of the machine learning model. Examples of hyperparameters may include number of layers, nodes, and/or connectivity. Generalizing across a wide range of variations in subjects may utilize deeper and/or more complex machine learning models (e.g., networks). For instance, a neural network that is trained for a wide range of facial poses (e.g., that is pose-invariant) may be more complex than networks trained on frontal faces (without other poses, for example), or networks trained on profile faces (without other poses, for example). More complex machine learning models (e.g., neural networks) may consume more compute throughput and power.

A target accuracy is a designated level of accuracy. For example, target accuracy may indicate a designated level of (e.g., threshold) inferencing accuracy or performance for a machine learning model structure, a machine learning model, a sub-network, etc. In some examples, the target accuracy may be set based on an input (e.g., specified by a user). In some examples, target accuracy may be expressed in terms of confidence and/or error likelihood. For instance, a machine learning model may produce inferences with a confidence (e.g., greater than 70%, 80%, 85%, 87.5%, 90%, 95%, etc.) and/or an error likelihood (e.g., less than 50%, 40%, 30%, 25%, 10%, 5%, etc.) to satisfy a target accuracy.

In some examples of the techniques described herein, a simpler (e.g., simplest) machine learning model that meets the criterion or criteria of the inferencing task (e.g., criterion for subject pose and/or illumination) may be selected from the machine learning model ensemble. Selecting a simpler machine learning model may reduce apparatus power consumption. In some examples, the apparatus may select the machine learning model or models from the machine learning model ensemble based on the inferencing level (e.g., L1, L2, L3, etc.) and/or based on the received indication of the environmental condition (e.g., an illumination indication IL1, IL2, etc., and/or a pose indication P1, P2, etc.). For instance, in a case that the inferencing level and/or received indication indicates a good illumination condition and/or an established pose condition (e.g., profile poses without frontal poses), the apparatus may select a simpler machine learning model or models for the illumination condition and/or pose condition. In a case that the inferencing level and/or the received indication indicates a more challenging environmental condition (e.g., multiple facial poses and low illumination), the apparatus may select a more generalized and/or complex machine learning model. In some examples, the selection of machine learning model(s) corresponding to each inferencing level and/or received indication may be determined based on a lookup table, rule(s), mapping(s), and/or model selection model. For example, the model selection model may be a machine learning model that is trained (based on error or error feedback in training, for example) to select a model or models from the machine learning model ensemble for a given inferencing level and/or received indication.

In some examples, controlling 104 a machine learning model structure may include dropping (e.g., removing, deactivating, etc.) a random selection of machine learning model components. Some approaches may utilize dropping machine learning model components during training to prevent overfitting. Some examples of the techniques described herein may drop a random selection of machine learning model components at runtime (e.g., after training, at an inferencing stage, etc.). In some examples, dropping a random selection of machine learning model components may include dropping random hidden units and connections corresponding to the random hidden units. Some benefits of dropping the random selection of machine learning model components may include reducing a processing load during inferencing, reducing a number of parameters utilized during inferencing, and/or reducing memory and memory bandwidth usage during inferencing. For instance, dropping machine learning model components may reduce a number of nodes that toggle during inferencing, thus reducing power consumption (e.g., active power usage). Active power usage is power consumed during the execution of instructions (e.g., the machine learning model structure). Active power may include a majority of the power consumed by the machine learning model(s) (e.g., neural network(s)). Standby power is power consumed when instructions (e.g., machine learning model structure) are not being executed. Standby power may include a minority of the power consumed, due to low-leakage transistors and power gating. Processing fewer nodes may imply the use of fewer parameters and may result in less memory and/or memory bandwidth consumed. Dropping a random selection of machine learning model components may reduce power consumption and/or improve battery life.

Some examples of the techniques for dropping a random selection of machine learning model components may be adaptive. For example, the extent (e.g., number of machine learning model components) of dropout may vary based on inferencing scenarios and/or an associated criterion or criteria, at start time and/or runtime. An amount of power savings may vary with the extent of the dropout. For example, when the machine learning model structure (e.g., neural network(s)) reaches deeper dropout, the number of nodes that toggle in the machine learning model structure may be reduced, which may lower the active power consumption. As each scenario presents different inference criteria (as a function of illumination and/or pose, for example), the extent of dropout may be changed according to the inferencing criterion or criteria. Accordingly, each scenario may result in reduced power consumption while meeting an accuracy target. Thus, average power consumption across scenarios may be lowered. Dropping a random selection of machine learning components may be based on the inferencing level (e.g., L1, L2, L3, etc.). For example, the apparatus may drop a larger random selection (e.g., larger number, larger proportion, etc.) of machine learning model components for L1 than for L3. For instance, the apparatus may drop a random selection of a percentage (e.g., 40%, 50%, 60%, 70%, etc.) of machine learning model components for L1. For a high inferencing level (e.g., L5), no machine learning model components may be dropped or a smaller random selection (e.g., 2%, 5%, 10%, etc.) of machine learning model components may be dropped. In some examples, the extent of machine learning components dropped corresponding to each inferencing level may be determined based on a lookup table, rule(s), mapping(s), and/or drop model. For example, the drop model may be a machine learning model that is trained (based on error or error feedback in training, for example) to select an amount of machine learning model components dropped for a given inferencing level.

Higher dropout rates may result in reduced accuracy. In some examples of the techniques described herein, higher dropout may be applied when the environmental condition is more favorable (e.g., a good illumination condition and/or a pose condition with a single pose). The accuracy gained due to a favorable environmental condition may compensate for the reduction in accuracy. Thus, a favorable environmental condition may allow the machine learning model structure to run at lesser power, without a net loss in accuracy. Some examples of the techniques described herein may be used to maintain an accuracy target by varying the dropouts according to the changing inferencing context. Some examples of the techniques described herein may allow for more greatly varying the accuracy if the use case tolerates the varying accuracy. Dropping a random selection of machine learning model components may provide a mechanism to tradeoff power consumption for accuracy.

In some examples, controlling 104 the machine learning model structure may include selecting a sub-network or sub-networks of machine learning model components. For example, the apparatus may select a layer or layers, a node or nodes, and/or a connection or connections of the machine learning model structure. The selected sub-network(s) (e.g., the selected machine learning model components) may be utilized for inference, while another portion or portions of the machine learning model may not be utilized (e.g., may be deactivated, removed, pruned, dropped, etc.). Selecting a sub-network or sub-networks may result in an improved machine learning model structure, while maintaining target accuracy. For example, selecting a sub-network or sub-networks may be equivalent to searching the machine learning model structure for an improved sub-network or sub-networks and/or removing other machine learning components. For example, in a large neural network there may exist a sub-network or sub-networks that may provide target accuracies for lower computation costs and/or lower power consumption.

In some examples, the sub-network or sub-networks may be selected adaptively. Some approaches for sub-network selection may be performed during training. In some examples of the techniques described herein, sub-network selection may be performed at runtime (e.g., after training, during inferencing, etc.). For instance, a sub-network or sub-networks may provide a target accuracy. A sub-network or sub-networks may provide a reduced processing load, which may result in power and/or throughput savings. A range of sub-networks may provide a range of accuracies (e.g., from 0% accuracy to a highest possible accuracy).

In some approaches to sub-network selection, the apparatus may identify a range of sub-networks corresponding to a range of accuracies. In some examples, the apparatus may select the sub-network or sub-networks based on a target accuracy. For example, the apparatus may select the sub-network or sub-networks that may provide the target accuracy with the environmental condition. In some examples, the apparatus may select the sub-network or sub-networks based on the inferencing level. For instance, for a lower inferencing level (e.g., L1), the apparatus may select a smaller sub-network (that may provide a target accuracy, for instance) than a larger sub-network (that may provide the target accuracy) for a higher inferencing level (e.g., L3). For example, at a compile time for a neural network, the apparatus may select a sub-network (e.g., a smallest sub-network) with a least amount of power consumption from sub-networks that may provide the target accuracy. For example, a statistical and/or machine learning approaches may be utilized to predict the power consumption and/or throughput of a sub-network on an apparatus (e.g., on given hardware). For instance, power consumption and/or accuracy of different sub-networks may be identified a priori. The identified sub-networks may be utilized for sub-network selection at runtime, which may allow for an improved tradeoff between power consumption and performance (e.g., accuracy) at runtime. In some examples, the sub-network selection corresponding to each inferencing level may be determined based on a lookup table, rule(s), mapping(s), and/or sub-network selection model. For example, the sub-network selection model may be a machine learning model that is trained (based on error or error feedback in training, for example) to select a sub-network of machine learning model components for a given inferencing level.

In some examples, controlling 104 the machine learning model structure may include controlling quantization. Quantization is representing a quantity with a discrete number. For example, quantization may refer to a number of bits utilized to represent a number. In some examples, quantization may be utilized to reduce a number of bits utilized to represent a number. For instance, 32-bit floating-point values may be utilized for training a machine learning model. At runtime, a smaller number of bits (e.g., 16-bit numbers, 8-bit numbers, 4-bit numbers, etc.) may be utilized in some cases. At inferencing, for example, 8-bit integers and/or 1-bit weights and activations may be utilized in some cases, which may result in reduced power consumption (e.g., area and/or energy savings).

In some examples, the apparatus may control quantization. For instance, quantization may be controlled adaptively. In some approaches, the machine learning model structure (e.g., neural network(s)) may be quantized at runtime (based on a target accuracy, for example). In some approaches, when a machine learning model is quantized, all layers may be quantized in the same format (e.g., all layers may be represented with 8-bit integers, or 4-bit integers, etc.). In some examples of the techniques described herein, the quantization may be adapted (based on a target accuracy, for instance). For example, each layer of the machine learning model structure may have a separate quantization. The quantization for a layer may depend on a factor or factors, such as weight distribution, layer depth, etc. The quantization per layer may be controlled (e.g., modified) at runtime. For example, the quantization for each layer may be controlled based on a target accuracy (e.g., maintaining a target accuracy for past quantization of a layer) and/or based on error feedback. In some examples, controlling quantization may reduce computation complexity and/or increase energy efficiency. In some examples, the quantization may be controlled based on the inferencing level. For instance, a lower quantization (e.g., 4-bit integers) for a layer or layers may be selected for a lower inferencing level (e.g., L1). A higher quantization (e.g., 16-bit integers) may be selected for a higher inferencing level (e.g., L3). In some examples, the amount of quantization corresponding to each inferencing level may be determined based on a lookup table, rule(s), mapping(s), and/or quantization model. For example, the quantization model may be a machine learning model that is trained (based on error or error feedback in training, for example) to select an amount of quantization for a given inferencing level.

In some examples, the apparatus may perform selecting a machine learning model from a machine learning model ensemble, dropping a random selection of machine learning model components, selecting a sub-network of machine learning model components, and/or controlling quantization. In some examples, operations may be performed in an order. For instance, selecting a machine learning model from a machine learning model ensemble may be performed before dropping a random selection, selecting a sub-network, and/or controlling quantization. For instance, selecting a machine learning model from a machine learning model ensemble may be performed at a beginning of runtime (e.g., start time). Once a machine learning model (e.g., network) is selected, further power savings may be extracted during runtime by performing random selection dropping, sub-network selection, and/or quantization control. Accordingly, the apparatus may reach lower power states during runtime. In some examples, other orders may be implemented, the order may vary, and/or operations may be repeated (e.g., iterated).

In some examples, the method 100 may include performing inferencing based on the controlled machine learning model structure. In some examples, error feedback may be determined based on the inferencing. Error feedback is a value or values that indicate a confidence or likelihood of error. For instance, the machine learning model structure may provide a confidence value and/or an error value with each inferencing result. The confidence value may indicate a likelihood that the inferencing result is correct. An error value may indicate a likelihood that the inferencing result is incorrect. In some examples, the error feedback may be utilized to further control the machine learning model structure. For instance, the apparatus may control the machine learning model structure based on the error feedback.

In some examples, the apparatus may increase or decrease machine learning model structure complexity based on the error feedback. For instance, if the error feedback indicates a confidence value that is above a target accuracy, the apparatus may decrease the machine learning model structure complexity. In some examples, the apparatus may select a machine learning model from a machine learning model ensemble, may drop more machine learning model components, may select a smaller sub-network, and/or may decrease quantization in a case that the confidence value is above a target accuracy. In some examples, the apparatus may select a machine learning model from a machine learning model ensemble, may drop fewer machine learning model components, may select a larger sub-network, and/or may increase quantization in a case that the confidence value is above a target accuracy.

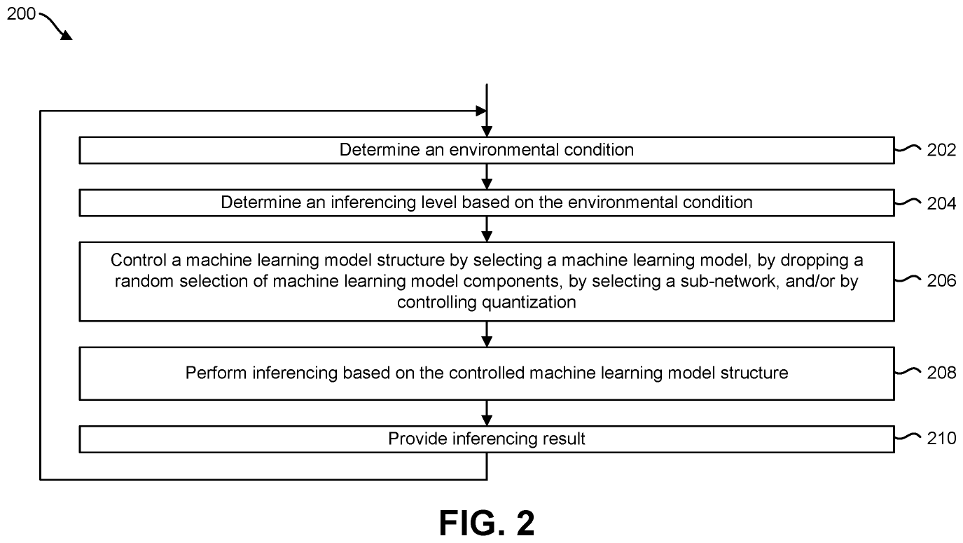

FIG. 2 is a flow diagram illustrating an example of a method 200 for controlling a machine learning model structure. The method 200 and/or an element or elements of the method 200 may be performed by an apparatus (e.g., electronic device). For example, the method 200 may be performed by the apparatus 302 described in connection with FIG. 3.

The apparatus may determine 202 an environmental condition. In some examples, determining 202 an environmental condition may be performed as described in relation to FIG. 1. For example, an apparatus may determine an illumination condition, a pose condition, and/or other environmental state based on sensed data and/or based on a received indication.

The apparatus may determine 204 an inferencing level based on the environmental condition. In some examples, determining 204 the inferencing level may be performed as described in relation to FIG. 1. For example, the apparatus may determine an inferencing level based on the environmental condition using a rule or rules (e.g., thresholds), a lookup table, and/or a selection model.

The apparatus may control 206 a machine learning model structure based on the environmental condition by selecting a machine learning model from a machine learning model ensemble, by dropping a random selection of machine learning model components (e.g., hidden node(s), hidden layer(s), etc.), by selecting a sub-network of machine learning model components, and/or by controlling quantization. In some examples, controlling 206 the machine learning model structure may be performed as described in relation to FIG. 1. For instance, the apparatus may select a machine learning model from a machine learning model ensemble, drop a random selection of machine learning model components (e.g., hidden node(s), hidden layer(s), etc.), select a sub-network of machine learning model components, and/or control quantization based on the inferencing level and/or based on a received indication. In some examples, each of the inferencing levels may be mapped to a respective machine learning model selection, to an amount (e.g., proportion, percentage, number, etc.) machine learning model components to randomly drop, to a sub-network selection, and/or to a quantization for the machine learning model structure. For example, the inferencing level may be mapped using a lookup table and/or a rule or rules (e.g., thresholds or case statement). For instance, each inferencing level may correspond to a machine learning model selection (e.g., L1 to model A, L2 to model B, L3 to model C, etc.), may correspond to a proportion of machine learning model components to drop (e.g., L1 to 70%, L2 to 50%, L3 to 20%, etc.), may correspond to a sub-network selection (e.g., L1 to sub-network X, L2 to sub-network Y, L3 to sub-network Z, etc.), and/or may correspond to an amount of quantization (e.g., L1 to 4-bit, L2 to 8-bit, L3 to 16-bit, etc.).

In some examples, selecting a machine learning model from the machine learning model ensemble may be based on a received indication (and may not be based on the inferencing level, for example). For instance, the machine learning model may be selected based on a received indication. Each potential indication may be mapped to a machine learning model selection from the ensemble using a lookup table and/or a rule or rules. For example, a first indication may correspond to model A, a second indication may correspond to model B, and a third indication may correspond to models A and B, etc.

The apparatus may perform 208 inferencing based on the controlled machine learning model structure. In some examples, performing 208 inferencing may be accomplished as described in relation to FIG. 1. For example, the apparatus may utilize the machine learning model structure to perform inferencing. For instance, the apparatus may provide inputs (e.g., image frame(s), audio signals, pose information, etc.) to the machine learning model structure, which may produce an inferencing result or results (e.g., object detection, image classification, voice recognition, route determination, etc.) with a confidence value(s) and/or error value(s). In some examples, the apparatus may determine error feedback based on the inferencing. For example, the confidence value(s) and/or error value(s) may be utilized as error feedback and/or may be utilized to determine the error feedback. In some examples, the confidence value(s) and/or error value(s) may be collected (by a background task, for instance) to determine error or error feedback. In some examples, the confidence value(s) and/or error value(s) may be the error (e.g., error feedback) or the error (e.g., error feedback) may be determined as a combination of values (e.g., average confidence over a period or number of inferences, average error over a period or number of inferences, etc.). In some examples, the apparatus may utilize the error feedback to control (e.g., modify) the machine learning model structure for further (e.g., subsequent) inferencing. In some examples, utilizing the error feedback to control the machine learning model structure may be performed as described in relation to FIG. 1.

The apparatus may provide 210 the inferencing result or results. For instance, the apparatus may store the inferencing result(s), may send the inferencing result(s) to another device, and/or may present the inferencing result(s) (on a display and/or in a user interface, for example). For example, the apparatus may present an object detection result (e.g., a marked image indicating and/or identifying a detected object), may present an image classification result, may present a voice recognition result, and/or may present a navigation result (e.g., a map and/or image with a marked route), etc. In some examples, the apparatus may perform an operation or operations based on the inferencing result(s). For example, the apparatus may track a detected object, present image frames that include a detected object (e.g., person, face, etc.), may calculate a proportion of frames that include an object, may control a vehicle (e.g., automobile, car, aircraft, drone, etc.) to follow a navigation route, may control a robot, may perform a command based on a recognized voice, etc. In some examples, operation(s), function(s), and/or element(s) of the method 200 may be omitted and/or combined.

FIG. 3 is a block diagram of an example of an apparatus 302 that may be used in controlling a machine learning model structure or structures. The apparatus 302 may be a device, such as a personal computer, a server computer, a printer, a 3D printer, a smartphone, a tablet computer, a robot, a vehicle, aircraft, etc. The apparatus 302 may include and/or may be coupled to a processor 304, and/or a memory 306. In some examples, the apparatus 302 may be in communication with another device or devices. The apparatus 302 may include additional components (not shown) and/or some of the components described herein may be removed and/or modified without departing from the scope of this disclosure.

The processor 304 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 306. The processor 304 may fetch, decode, and/or execute instructions (e.g., environmental condition determination instructions 310, inferencing level determination instructions 312, machine learning model structure modification instructions 314, and/or operation instructions 318) stored in the memory 306. In some examples, the processor 304 may include an electronic circuit or circuits that include electronic components for performing a functionality or functionalities of the instructions (e.g., environmental condition determination instructions 310, inferencing level determination instructions 312, machine learning model structure modification instructions 314, and/or operation instructions). In some examples, the processor 304 may perform one, some, or all of the functions, operations, elements, methods, etc., described in connection with one, some, or all of FIGS. 1-5.

The memory 306 may be any electronic, magnetic, optical, or other physical storage device that contains or stores electronic information (e.g., instructions and/or data). Thus, the memory 306 may be, for example, Random Access Memory (RAM), Electrically Erasable Programmable Read-Only Memory (EEPROM), a storage device, and/or an optical disc, etc. In some implementations, the memory 306 may be a non-transitory tangible machine-readable storage medium, where the term “non-transitory” does not encompass transitory propagating signals. The processor 304 may be in electronic communication with the memory 306.

In some examples, the apparatus 302 may also include a data store (not shown) on which the processor 304 may store information. The data store may be volatile and/or non-volatile memory, such as Dynamic Random Access Memory (DRAM), EEPROM, magnetoresistive random-access memory (MRAM), phase change RAM (PCRAM), memristor, and/or flash memory, etc. In some examples, the memory 306 may be included in the data store. In some examples, the memory 306 may be separate from the data store. In some approaches, the data store may store similar instructions and/or data as that stored by the memory 306. For example, the data store may be non-volatile memory and the memory 306 may be volatile memory.

In some examples, the apparatus 302 may include an input/output interface (not shown) through which the processor 304 may communicate with an external device or devices (not shown), for instance, to receive and/or store information (e.g., machine learning model structure data 308, received indication, etc.). The input/output interface may include hardware and/or machine-readable instructions to enable the processor 304 to communicate with the external device or devices. The input/output interface may enable a wired or wireless connection to the external device or devices. In some examples, the input/output interface may further include a network interface card and/or may also include hardware and/or machine-readable instructions to enable the processor 304 to communicate with various input and/or output devices, such as a keyboard, a mouse, a display, another apparatus, electronic device, computing device, etc., through which a user may input instructions and/or indications into the apparatus 302. In some examples, the apparatus 302 may receive machine learning model structure data 308 from an external device or devices (e.g., scanner, removable storage, network device, etc.).

In some examples, the memory 306 may store machine learning model structure data 308. The machine learning model structure data 308 may be generated by the apparatus 302 and/or received from another device. Some examples of machine learning model structure data 308 may include data indicating a machine learning model or models (e.g., neural network(s)), a machine learning model ensemble, machine learning model components (e.g., layers, nodes, connections, etc.), weights, quantizations, sub-networks, etc. The machine learning model structure data 308 may indicate a machine learning model structure and/or machine learning model components. The machine learning model structure data 308 may include data indicating machine learning model components that are deactivated, removed, selected, not selected, etc. In some examples, the machine learning model structure data 308 may include data indicating accuracies of machine learning models, sub-networks, quantizations, etc., and/or may include data indicating a target accuracy or accuracies. In some examples, some or all of the machine learning model(s), machine learning model component(s), and/or sub-network(s), etc., of the machine learning model structure data 308 may be pre-trained. In some examples, some or all of the machine learning model(s), machine learning model component(s), and/or sub-network(s), etc., of the machine learning model structure data 308 may be trained on the apparatus 302.

The memory 306 may store environmental condition determination instructions 310. The processor 304 may execute the environmental condition determination instructions 310 to determine an environmental condition (e.g., a state or states of an environment). For instance, the processor 304 may execute the environmental condition determination instructions 310 to determine an environmental condition based on an input. For example, the apparatus 302 may capture and/or receive image frame(s), ambient light level(s), audio, and/or motion, etc., and/or may receive an indication from an input device. For instance, the apparatus 302 may include and/or may be coupled to a sensor or sensors (e.g., camera(s), light sensors, motion sensors, microphones, etc.) and/or may include and/or may be coupled to an input device or devices (e.g., touchscreen, mouse, keyboard, etc.). In some examples, the input may be captured by a sensor after the machine learning model structure (e.g., machine learning model(s), machine learning model component(s), neural network(s)) is trained. In some examples, the processor 304 may execute the environmental condition determination instructions 310 to determine an environmental condition (e.g., illumination condition, pose condition, etc.) as described in relation to FIG. 1 and/or FIG. 2.

The memory 306 may store inferencing level determination instructions 312. The processor 304 may execute the inferencing level determination instructions 312 to determine an inferencing level based on the environmental condition. For instance, the processor 304 may execute the inferencing level determination instructions 312 to determine an inferencing level based on the environmental condition and/or error feedback. For instance, the processor 304 may determine a preliminary inferencing level based on the environmental condition and/or may adjust the preliminary inferencing level based on the error feedback (e.g., may lower the first inferencing level if the error feedback is beyond a target range above a target accuracy, may increase the preliminary inferencing level if the error feedback is below the target accuracy, or may not adjust the preliminary inferencing level if the error feedback is within a target range above the target accuracy). In some examples, determining the inferencing level may be accomplished as described in relation to FIG. 1 and/or FIG. 2.

The memory 306 may store machine learning model structure modification instructions 314. The processor 304 may execute the machine learning model structure modification instructions 314 to modify a machine learning model structure or structures. For instance, the processor 304 may execute the machine learning model structure modification instructions 314 to modify a machine learning model structure based on the inferencing level to regulate apparatus 302 power consumption. For example, the processor 304 may modify the machine learning model structure to reduce the complexity, processing load, and/or power consumption of the machine learning model structure while maintaining (e.g., satisfying) a target accuracy. In some examples, modifying the machine learning model structure may be accomplished as described in relation to FIG. 1 and/or FIG. 2.

In some examples, the processor 304 may execute the operation instructions 318 to perform an operation based on inferencing results provided by the machine learning model structure. For example, the processor 304 may present the inferencing results, may store the inferencing results in the memory 306, and/or may send the inferencing results to another device or devices. In some examples, the processor 304 may present the inferencing results on a display and/or user interface. In some examples, the processor 304 may control a vehicle (e.g., self-driving car, drone, etc.), may send a message (e.g., indicate that a person is detected from an image of a security camera), may create a report (e.g., a number of parts were detected on an assembly line from images of a camera), etc.

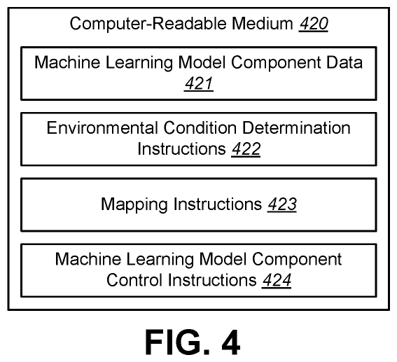

FIG. 4 is a block diagram illustrating an example of a computer-readable medium 420 for controlling machine learning model components. The computer-readable medium 420 may be a non-transitory, tangible computer-readable medium 420. The computer-readable medium 420 may be, for example, RAM, EEPROM, a storage device, an optical disc, and the like. In some examples, the computer-readable medium 420 may be volatile and/or non-volatile memory, such as DRAM, EEPROM, MRAM, PCRAM, memristor, flash memory, and the like. In some implementations, the memory 306 described in connection with FIG. 3 may be an example of the computer-readable medium 420 described in connection with FIG. 4.

The computer-readable medium 420 may include code (e.g., data and/or executable code or instructions). For example, the computer-readable medium 420 may include machine learning model component data 421, environmental condition determination instructions 422, mapping instructions 423, and/or machine learning model component control instructions 424.

In some examples, the computer-readable medium 420 may store machine learning model component data 421. Some examples of machine learning model component data 421 may include data indicating a layer or layers, node or nodes, connection or connections, etc., of a machine learning model or models. For example, the machine learning model component data 421 may include data indicating a machine learning model component or components of a machine learning model structure.

In some examples, the environmental condition determination instructions 422 are code to cause a processor to determine an environmental condition indicative of a signal-to-noise ratio (SNR) to be experienced by a sensor. In some examples, this may be accomplished as described in connection with FIG. 1, FIG. 2, and/or FIG. 3. The SNR is a condition or measure of discernibility of target data (e.g., objects, target sounds, etc.). In some examples, the SNR may be calculated and/or expressed as a ratio of an amount (e.g., magnitude) of a target signal to an amount (e.g., magnitude) of noise.

In some examples, the environmental condition determination instructions 422 may cause a processor to utilize an image or images of an environment experienced by an image sensor and/or to utilize data from a light sensor or sensors in an environment to determine an illumination condition. For instance, the illumination condition may be indicative of an optical SNR experienced by the image sensor(s) and/or light sensor(s). For instance, increased brightness may correspond to an increased optical SNR. In some examples, the environmental condition determination instructions 422 may cause a processor to utilize an audio signal or signals experienced by an audio sensor (e.g., microphone(s)) to determine an acoustic condition. An acoustic condition is an indication of a state of sound (e.g., target sound, such as user speech or music) of an environment. For instance, an acoustic condition may indicate volume, loudness, sound intensity, and/or noise, etc. In some examples, an acoustic condition may be expressed in units of decibels (dB). In some examples, the acoustic condition may be expressed as a value, a histogram of values, an average of values, a maximum value (from a set of values), a minimum value (from a set of values), etc. In some examples, increased target sound and/or decreased noise may correspond to increased acoustic SNR.

In some examples, the mapping instructions 423 are code to cause a processor to map the environmental condition to an inferencing level. In some examples, this may be accomplished as described in connection with FIG. 1, FIG. 2, and/or FIG. 3. For example, the mapping instructions 423 may cause a processor to map the environmental condition to an inferencing level using a lookup table, rule or rules, and/or selection model. For instance, the mapping instructions 423 may cause a processor to look up an inferencing level corresponding to the environmental condition, to select an inferencing level by applying the rule(s) to the environmental condition, and/or to infer an inferencing level by inputting the environmental condition into a selection model (e.g., machine learning model, neural network, etc.).

In some examples, the machine learning model component control instructions 424 are code to cause the processor to control machine learning model components based on the inferencing level. In some examples, this may be accomplished as described in relation to FIG. 1, FIG. 2, and/or FIG. 3. For instance, the machine learning model component control instructions 424 may cause a processor to remove (e.g., randomly drop) a first subset of the machine learning model components, to select a second subset (e.g., sub-network) of the machine learning model components, and/or to select a quantization or quantizations for the machine learning model components (e.g., layers) based on the inferencing level.

FIG. 5 is a block diagram illustrating an example of components that may be utilized to control a machine learning model structure or structures. In some examples, one, some, or all of the components described in relation to FIG. 5 may be included in and/or implemented by the apparatus 302 described in relation to FIG. 3. In some examples, a component or components described in relation to FIG. 5 may perform one, some, or all of the functions and/or operations described in relation to FIG. 1, FIG. 2, FIG. 3, and/or FIG. 4. The components described in relation to FIG. 5 include an image sensor 536, an image signal processor 538, an encoder 540, a light sensor 542, an illumination level determination 544 component, a first inferencing level determination 546 component, a second inferencing level determination 548 component, a machine learning model structure control 550 component, a selection dropping 552 component, a sub-network selection 554 component, a quantization control 556 component, an ensemble selection 558 component, and a machine learning model structure 560 component. A component of components described in FIG. 5 may be implemented in hardware (e.g., circuitry) and/or a combination of hardware and instructions (e.g., a processor with instructions). In some examples where components are implemented in separate hardware elements, the components may communicate by asserting and/or sending signals.

The components described in relation to FIG. 5 may acquire images (e.g., still images and/or videos) from an image sensor 536 (e.g., camera), determine an inferencing level or levels, and control a machine learning model structure. The image sensor 536 may capture frames to be inferenced. Examples of the image sensor 536 may include a camera with a characteristic or characteristics suitable for capturing images for inferencing. For example, a camera may have a field of view (FOV), low light capture capability, resolution, illumination (e.g., light emitting diode (LED) illumination), infrared (IR) light sensitivity and/or visible light sensitivity to enable the camera to capture images for inferencing. An image signal processor 538 may be included in some implementations (for inferencing DNNs that are trained on Joint Photographic Experts Group (JPEG) frames, for example). In some examples, the image sensor 536 and/or image signal processor 538 may output raw Bayer frames (for DNNs that have been trained to inference on raw Bayer frames, for instance).

The illumination level determination 544 component may determine the instantaneous Illumination levels. For example, the illumination level determination 544 component may receive an input or inputs from image sensor 536 and/or image signal processor 538 in the form of illuminance values or a histogram of illuminance values. In some examples, the illumination level determination 544 may sample ambient light conditions from the light sensor 542. The input or inputs may be sampled during runtime periodically or synchronized to a function of an image sensor (e.g., camera) frame rate. In some examples, a sensing rate and/or illumination level determination rate may match a rate of first inferencing level determination 546 and/or second inferencing level determination 548. The illumination level determination 544 component may output an illumination level. The illumination level is a level of illumination in an environment. The illumination level may be an example of the illumination condition described herein. As the input(s) are sampled at runtime, the illumination level may be updated.

The first inferencing level determination 546 component may determine a first inferencing level based on the illumination level. In some examples, the first inferencing level determination 546 component may determine the first inferencing level as described in relation to FIG. 1, FIG. 2, FIG. 3, and/or FIG. 4. For example, the first inferencing level determination 546 component may utilize the illumination level (e.g., illumination condition) to determine the first inferencing level (e.g., L1, L2, etc.) using a lookup table, a rule or rules, and/or a selection model. In some examples, the selection model may be trained based on error or error feedback in training.

As described herein, a machine learning model structure 560 may produce an inferencing result 564 and corresponding error feedback 562 (e.g., an error value, a confidence value, a combination of error values over a period, and/or a combination of confidence values over a period, etc.). The error feedback 562 may be provided to the first inferencing level determination 546 component and/or the second inferencing level determination 548 component. The error feedback 562 may be a measure of performance of the machine learning model structure 560. In some examples, during training, the selection model may be adjusted based on a weighted error across varying illumination conditions to determine an inferencing level to estimate. When the machine learning model structure 560 is deployed, the first inferencing level determination 546 component may continue to improve in real-world situations.

In some examples, an environment may be equipped with multiple image sensors (e.g., cameras) and/or machine learning model structures for inferencing. To accommodate coordination and/or increase global performance, the first inferencing level determination 546 component may send signals 566 to and/or receive signals 566 from another inferencing device or devices.

In some examples, the second inferencing level determination 548 component may receive an indication 568 of an environmental condition. For example, the indication 568 may indicate a set environmental condition. In some examples, the indication 568 may be received from a user at a time of installation and/or deployment of an apparatus (e.g., camera) in the environment. For instance, the user may provide the indication 568 that indicates a set environmental condition based on a location of the image sensor 536. The set environmental condition may depend on illumination and pose. For example, the indication 568 may indicate a predominant subject illumination for the location of the image sensor 536. For instance, a camera facing a window may predominantly capture backlit subjects. Such a scenario may be more demanding on the inferencing to reach target accuracy. In this scenario, the user may provide an indication 568 of a low set illumination level. This may cause a more complex machine learning model structure (e.g., deeper network) with higher precision to be selected to provide higher accuracy. In some examples, the second inferencing level determination 548 component may determine and/or provide a set illumination level or levels (e.g., IL1, IL2, etc.) and/or a set inferencing level based on the illumination level(s).

In some examples, the indication 568 may indicate a set pose level relative to the image sensor 536 (e.g., camera). A set pose level may indicate an object pose for inferencing. For instance, a camera mounted on the side of a door may be used for profile detection. In another example, a camera covering a room may be utilized to inference on frontal and profile faces. Depending on the indication 568, the second inferencing level determination 548 component may determine and/or provide a set pose level (e.g., PL1, PL2, etc.). In some examples, the second inferencing level determination 548 component may determine a set inferencing level (e.g., SL1, SL2, SL3, etc.) based on the indication 568. For example, the second inferencing level determination 548 component may map an indication 568 to a set illumination level, a set pose level, and/or a set inferencing level (SL1, SL2, SL3, etc.). The indication may be mapped to the set illumination level, the set pose level, and/or the set inferencing level using a lookup table, a rule or rules, and/or a selection model.

In some examples, the second inferencing level determination 548 component may utilize the error feedback 562. The error feedback 562 may be utilized to reduce error. For example, the error feedback may be utilized to reduce error during deployment. In some examples, error metrics may be utilized to reduce error in training.

As illustrated in the example of FIG. 5, the first inferencing level determination 546 component and/or the second inferencing level determination 548 component may perform inferencing level determination as described in relation to FIG. 1, FIG. 2, FIG. 3, and/or FIG. 4. For instance, the inferencing level determined by the first inferencing level determination 546 component and/or the set inferencing level determined by the second inferencing level determination 548 component may be examples of the inferencing levels described in relation to FIG. 1, FIG. 2, FIG. 3, and/or FIG. 4. In some examples, the set inferencing levels determined by the second inferencing level determination 548 component may be determined based on a received indication 568 and the inferencing levels determined by the first inferencing level determination 546 component may be determined based on sensed data.

The machine learning model structure control 550 component may control the machine learning model structure 560. In some examples, the machine learning model structure control 550 component may map the set inferencing level (from the second inferencing level determination 548 component, for instance) and/or the inferencing level (from the first inferencing level determination 546 component, for instance) to versions of the machine learning model structure 560. In some examples, up to four variations may be utilized to control the machine learning model structure. Other numbers of variations may be utilized in other examples. For instance, one variation may be ensemble selection 558, another variation may be selection dropping 552, another variation may be sub-network selection 554, and another variation may be quantization control 556. In some examples, ensemble selection 558 may be a static variation, while selection dropping 552, sub-network selection 554, and quantization control 556 may be dynamic variations (e.g., dynamic updates for adaptations to an environmental condition). In some examples, the mapping may be based on a pre-trained selection model or models for the first inferencing level determination 546 and the second inferencing level determination 548, may be based on a lookup table (which may be created based on training values, for instance), and/or may be based on a rule or rules. During training, a selection model or models and the machine learning model structure 560 may be subject to varying environmental conditions (e.g., illumination conditions) and the inferencing level or levels may be varied until a balance between accuracy and power consumption is reached.

In some examples, the ensemble selection 558 may operate as described in relation to FIG. 1, FIG. 2, FIG. 3, and/or FIG. 4. In some examples, the selection dropping 552 may operate as described in relation to FIG. 1, FIG. 2, FIG. 3, and/or FIG. 4. In some examples, the sub-network selection 554 may operate as described in relation to FIG. 1, FIG. 2, FIG. 3, and/or FIG. 4. In some examples, the quantization control 556 may operate as described in relation to FIG. 1, FIG. 2, FIG. 3, and/or FIG. 4. For example, the selection dropping 552, the sub-network selection 554, the quantization control 556, and/or the ensemble selection 558 may be utilized to vary aspects of the machine learning model structure 560 at runtime based on an environmental condition, based on an inferencing level or levels, and/or based on error feedback.

An example of operation of the components described in relation to FIG. 5 is given as follows. The image sensor 536 may capture a frame or frames, which may be processed by the image signal processor 538. The frame(s) may be provided to the encoder 540. The encoder 540 may format the frame(s) for inferencing. The formatted frame(s) may be provided to the machine learning model structure 560 for inferencing. The machine learning model structure 560 may produce an inferencing result or results 564 and corresponding error feedback 562. The image sensor 536 and/or the image signal processor 538 may produce illuminance values, a statistic or statistics, and/or a histogram.

The illumination level determination 544 component may obtain illuminance values from the light sensor 542, from the image sensor 536, and/or from the image signal processor 538. In some examples, the image sensor 536 and/or image signal processor 538 may provide statistics or a histogram. Based on the inputs from the light sensor 542, from the image sensor 536, and/or from the image signal processor 538, the illumination level determination 544 component may determine an illumination condition. The illumination condition may be provided to the first inferencing level determination 546.

The first inferencing level determination 546 component may utilize the illumination condition to determine an inferencing level or levels. In some examples, the first inferencing level determination 546 component may receive the error feedback 562 from the machine learning model structure 560. In some examples, the first inferencing level determination 546 component may utilize a selection model to determine the inferencing level. During training, the selection model may be trained to reduce error. During inferencing, the selection model may be utilized to reduce error.

The second inferencing level determination 548 component may utilize an indication 568 to determine a set inferencing level. In some examples, the second inferencing level determination 548 component may utilize a selection model (e.g., a separate selection model from the selection model utilized by the first inferencing level determination 546 component) to determine the set inferencing level. During training, the selection model (e.g., weights) may be trained to reduce error. For example, error or error feedback may be utilized during training to train the selection model for selecting a machine learning model or models from a machine learning model ensemble. During inferencing, the selection model may be utilized to reduce error.

The machine learning model structure control 550 component may control (e.g., adjust and/or modify) the machine learning model structure 560 based on the set inferencing level (from the second inferencing level determination 548 component, for instance) and/or the inferencing level (from the first inferencing level determination 546 component, for instance). The machine learning model structure control 550 component may utilize selection dropping 552, sub-network selection 554, quantization control 556, and/or ensemble selection 558 to control the machine learning model structure 560 to reduce average power consumption based on the environmental condition and/or the inferencing level(s).

The machine learning model structure 560 may produce error feedback 562 (e.g., error value(s) and/or confidence value(s)) corresponding to an inferencing result or results 564. The error feedback 562 may be provided to the first inferencing level determination 546 component and/or to the second inferencing level determination 548 component.

Some examples of the techniques described herein may be beneficial. Because inferencing may consume a relatively large amount of power and/or may put a strain on battery consumption, some of the techniques described herein may be utilized to increase the efficiency of devices based on an environmental condition and/or inferencing target accuracy. Some of the techniques described herein may be implemented in a variety of devices (e.g., smartphones, printers, tablet devices, laptop computers, desktop computers, always-on cameras, vehicles, etc. For instance, some examples of the techniques described herein may be beneficial for battery-life challenged drones, robots, and/or self-driving cars. For example, a variety of devices may benefit from low-power camera inferencing enabled by the techniques described herein.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples of systems and methods are described herein, the systems and methods are not limited to the examples. Variations of the examples described herein may be implemented within the scope of the disclosure. For example, operations, functions, aspects, or elements of the examples described herein may be omitted or combined.

1. A method, comprising:
controlling a machine learning model structure based on an environmental condition to control apparatus power consumption associated with a processing load of the machine learning model structure.

2. The method of claim 1, further comprising detecting the environmental condition, wherein the environmental condition is based on illumination or pose.

3. The method of claim 1, wherein controlling the machine learning model structure comprises determining an inferencing level based on the environmental condition.

4. The method of claim 3, wherein determining the inferencing level is based on an inverse relationship between an illumination condition and the inferencing level.

5. The method of claim 3, wherein controlling the machine learning model structure comprises dropping a random selection of machine learning model components.

6. The method of claim 3, wherein controlling the machine learning model structure comprises selecting a sub-network of machine learning model components.

7. The method of claim 3, wherein controlling the machine learning model structure comprises controlling quantization.

8. The method of claim 1, further comprising receiving an indication of the environmental condition.

9. The method of claim 8, wherein controlling the machine learning model structure comprises selecting a machine learning model from a machine learning model ensemble based on the indication.

10. The method of claim 1, further comprising:
performing inferencing based on the controlled machine learning model structure;
determining error feedback based on the inferencing; and
controlling the machine learning model structure based on the error feedback.

11. An apparatus, comprising:
a memory;
a processor in electronic communication with the memory, wherein the processor is to:
determine an environmental condition based on an input;
determine an inferencing level based on the environmental condition; and
modify a machine learning model structure based on the inferencing level to regulate apparatus power consumption.

12. The apparatus of claim 11, wherein determining the inferencing level is based on the environmental condition and error feedback.

13. The apparatus of claim 12, wherein the input is captured by a sensor after the machine learning model structure is trained.

14. A non-transitory tangible computer-readable medium storing executable code, comprising:
code to cause a processor to determine an environmental condition indicative of a signal-to-noise ratio to be experienced by a sensor;
code to cause the processor to map the illumination condition to an inferencing level; and
code to cause the processor to control machine learning model components based on the inferencing level.

15. The computer-readable medium of claim 14, wherein the code to cause the processor to control the machine learning model components comprises code to cause the processor to remove a first subset of the machine learning model components, to select a second subset of the machine learning model components, or to select a quantization for the machine learning model components based on the inferencing level.
